(19) United States
(12) Patent Application Publication
(10) Pub. No.: US 2026/0145361 A1
(43) Pub. Date: May 28, 2026

(54) 3D PRINTING OF CEMENTITIOUS MATERIAL WITH DYNAMIC CONTROL

(71) Applicant: CEM TECH LLC, Solana Beach, CA (US)

(72) Inventors: Michael Loren Taylor, Carlsbad, CA (US); Mario R. Arredondo Fernandez, Solana Beach, CA (US)

(21) Appl. No.: 18/959,222

(22) Filed: Nov. 25, 2024

(51) Int. Cl. B28B 17/00; B28B 1/00; B33Y 30/00; B33Y 40/00; B33Y 50/02

(52) U.S. Cl. CPC B28B 17/0072; B28B 1/001; B33Y 30/00; B33Y 40/00; B33Y 50/02

(57) ABSTRACT

A 3D printing system for printing of cementitious material, comprising: a mixer configured to mix the cementitious material; a plurality of bins configured to hold and supply material to the mixer; a pump configured to provide the cementitious material to the deposition nozzle; a deposition nozzle configured to extrude cementitious material; a heating element in communication with the deposition nozzle, the heating element configured to transfer heat to the cementitious material within an interior portion of the mixing and deposition nozzle; and at least one sensor configured to generate temperature readings for the cementitious material; and a controller coupled with the at least one sensor, the pump and the bins, and configured to receive the temperature readings, and control the pump, the amount of material being supplied by the bins, and the heating element so as to ensure that the hardening process of the cementitious material is optimum.

### BACKGROUND

### Field of the Invention

The embodiments described herein are generally directed to 3-Deminsional (3D) printing of cementitious material, and more particularly to dynamic control of the various components that comprise the mixture of the cementitious material.

### Description of the Related Art

In 3D concrete printing various materials/components are mixed in a mixer, often held in a tank and then pumped to a robotically controlled nozzle. For 3D printed concrete, buildability and extrudability are two of the most critical design properties for the mix of materials. Extrudability is the mixture's ability to pass through the nozzle, while buildability is the capacity to support additional layers. These properties are governed by the consistency, cohesiveness, and stability of the mixture, which stem from the mix design and selected materials. For both properties, a balance must be met between stiffness and workability. A stiff mix will increase strength, but decrease flow rate and print speed, potentially clogging the printer head. Conversely, decreasing the stiffness too much may increase workability and extrudability at the expense of strength and buildability. Stated another way, a stiff mix will increase “buildability”, but decrease “pumpability” increasing energy required to pump, causing undo wear on the machine, and can causing potentially system failures including clogging from mix through deposition nozzle. Conversely, decreasing the stiffness too much may increase “pumpability” and “extrudability” at the expense of strength and/or “buildability”.

Since concrete is printed in layers, layers must sufficiently bond to each other to allow for proper curing and full-strength capacity. Significant research has been conducted to create an optimal mix for 3D printing, although there are no current industry standards; however, the use of supplementary cementitious materials (SCMs), or admixtures such as metakaolin, fly ash, silica fume, and superplasticizers are common in all 3D printed concrete mixtures.

Thus, the main components of a 3D concrete printing system are the mixer, where the materials are mixed and a pump for pumping the mixed concrete ultimately to the extrusion nozzle. The nozzle is then robotically controlled by either a robotic arm or a gantry system. A 3D printing system will also include a controller that can be programmed to control eh robotics in order to print the desired pattern/shape.

The pump can be configured to pump the mixture directly from the mixer to the nozzle with no intermediary holding area. The pressure extending from the mortar pump directly for extrusion. Alternatively, an intermediate holding hopper often unsealed and open top, which feeds the nozzle through a mechanical type screw auger. In this system pump pressure is eliminated at the hopper. In another alternative configuration a sealed mixing cell can be include prior to extrusion nozzle. In such a configuration, the pump pressure pushes material through a mechanical mixing cell prior to the extrusion nozzle. Other systems, can comprise two pumping units, one at the source, and a second maintaining a balanced line push pull with the original push pump. This system providing consistent pumping pressure less impacted by intermediate criteria including temperature, distance, pressure, hose length, hose diameter...

The material is then extruded, under control of the controller and via the robotics, layer over layer.

The mixture includes cementitious material. Cementitious materials refer to materials that develop binding capabilities when mixed with water. Following is a list of some of the applicable cement binders for 3D concrete printing: Ordinary Portland Cement; Calcium Aluminate Cement; Calcium Sulfoaluminate Cement; Slag Cement; Mag Oxide Cement; and Geopolymer Cement.

When the cementitious material reacts with water, the reaction creates “heat of hydration”. Heat of hydration is primarily due to the exothermic reactions between water and the various cement compounds. Heat of hydration is different for different cement binders. Generally, cement binders that react faster create more heat. With 3D concrete printing, it is very important to have full control over all functions or aspects of the mortar, and even to be able to adjust some or all of those aspects during the printing session to accommodate for changing conditions. Temperature is a very important aspect in cement binders and binder admixtures, and therefore in 3D concrete printing.

Conventional 3d Cement printing methodologies can use one or more of the following to control heat of hydration: chemical admixtures, mineral admixtures, and some form of temperature control, but this is conventionally done at the mixer and is based on data gathered under lab conditions. Unfortunately, actually printing does not occur under lab conditions and such factors as ambient temperature, humidity, etc., can impact the mixing of the material.

But by controlling heat of hydration, the fresh state, intermediate state, and hardened sate properties of the cement binder can be controlled. The fresh state properties include: workability, consistency, setting time, heat of hydration, bleeding, and segregation. The intermediate sate properties include the initial set. While the hardened state properties include: compressive strength, tensile strength, durability, shrinkage, porosity, permeability, and elastic modulus.

But adjusting these aspects using chemicals, and sometimes ice or hot water in the mixer, based on experiments and observations performed under lab conditions is really not sufficient to produce perfect printed lines that stack esthetically pleasingly one on top of the other, with predictable critical to quality criteria being met. The ongoing problem is that a certain amount of open time for inter layer deposition is required, but not so much that the binder is still soft and cannot support the weight of the stacking layers. Achieving this balance with conventional systems has proved elusive.

### SUMMARY

Accordingly, systems and methods described herein are disclosed for dynamic 3-Deminsional (3D) concrete printing.

According to one aspect, A 3D printing system for printing of cementitious material, comprising: a mixer configured to mix the cementitious material; a plurality of bins configured to hold and supply material to the mixer; a pump configured to provide the cementitious material to the deposition nozzle; a deposition nozzle configured to extrude cementitious material; a heating element in communication with the deposition nozzle, the heating element configured to transfer heat to the cementitious material within an interior portion of the mixing and deposition nozzle; and at least one sensor configured to generate temperature readings for the cementitious material; and a controller coupled with the at least one sensor, the pump and the bins, and configured to receive the temperature readings, and control the pump, the amount of material being supplied by the bins, and the heating element so as to ensure that the hardening process of the cementitious material is optimum.

According to another aspect, a 3D printing system for printing of cementitious material, comprising: a mixer configured to mix the cementitious material; a plurality of bins configured to hold and supply material to the mixer; a pump configured to provide the cementitious material to the deposition nozzle; a deposition nozzle configured to extrude cementitious material, receive materiel at the nozzle, and wherein the deposition nozzle comprises a mixing chamber and an auger for mixing at the cementitious material at the nozzle; a heating element in communication with the deposition nozzle, the heating element configured to transfer heat to the cementitious material within an interior portion of the mixing and deposition nozzle; and at least one sensor configured to generate temperature readings for the cementitious material; and a controller coupled with the at least one sensor, the pump and the bins, and configured to receive the temperature readings, and control the pump, the amount of material being supplied by the bins, the volume of the material received at the nozzle, and the heating element so as to ensure that the hardening process of the cementitious material is optimum.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates a dynamic 3C concrete printing system in accordance with one example embodiment; and

FIGS. 4-6 illustrate example nozzle designs for use in the system of FIG. 3, according to several embodiments.

### DETAILED DESCRIPTION

In an embodiment, systems, methods, and non-transitory computer-readable media are disclosed for dynamic 3-Deminsional (3D) concrete printing.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

### Infrastructure

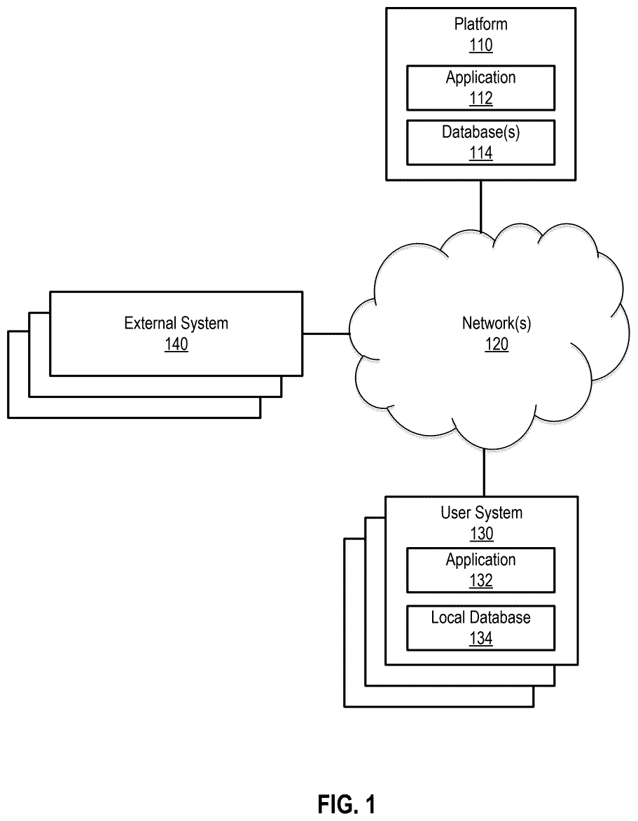

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes (e.g., methods or functions, implemented as software modules) described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120. It should be noted that for the systems described herein one or more of the one or more user systems 130 or one or more of the one or more external systems 140 can be a robot with controller configured to implement a dynamic 3D printing process as described herein. It should be clear therefore that via networking, i.e., network(s) 120, multiple robots can be configured and controlled from a remote platform 110, which may or may not be co-located with the multiple robots.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes (e.g., methods and functionality), storage, and/or the like, described herein. For example, in such an embodiment, a client application 132, executing on one or more user system(s) 130, may interact with a server application 112 executing on platform 110 to execute one or more or a portion of one or more of the various process(es) described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes (e.g., methods or functions) described herein.

### Example Processing Device

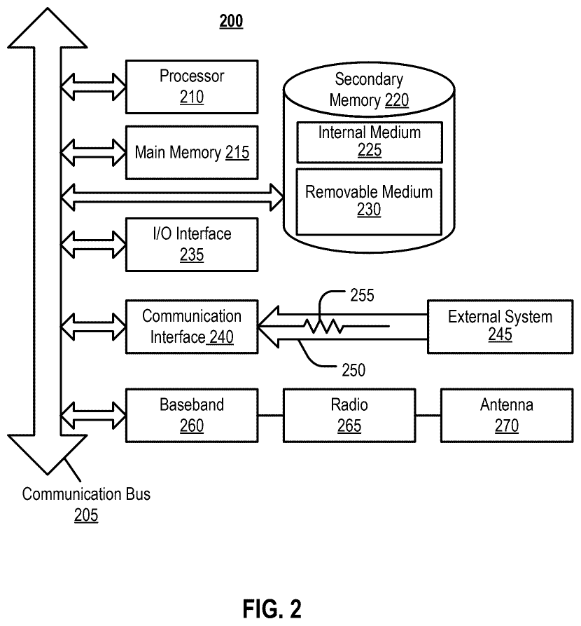

FIG. 2 is a block diagram illustrating an example wired or wireless system 200 that may be used in connection with various embodiments described herein. For example, system 200 may be used as or in conjunction with one or more of the processes (e.g., to store and/or execute the software), including any methods or functions, described herein, and may represent components of platform 110, user system(s) 130, external system(s) 140, and/or other processing devices described herein, such as controller 114 as described below. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various process(es) of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various process(es) of the disclosed embodiments.

### Dynamic 3d Printing System

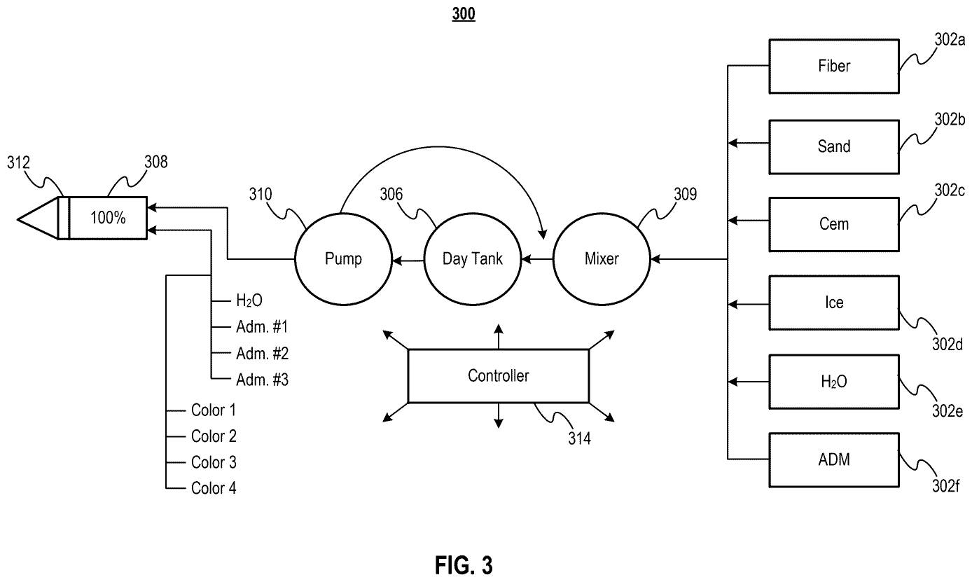

FIG. 3 illustrates a dynamic 3C concrete printing system 300 in accordance with one example embodiment. As can be seen, system 300 can comprise a number of bins, or reservoirs or sources (bins) 302 that are configured to hold and supply material to the mixer 304. The bins 302 can supply fiber (302a), sand (302b), cementitious material (302c), ???(302d), water (302e), and one or more admixtures (302f). The mix can then be pumped, via pump 310, to a nozzle 308, which will be attached a to a robot (not shown) as described above. Alternatively, the mix may go to a day tank 306 and then be transferred to nozzle 308.

As can also be seen, various material can also be added at the nozzle 308, such as water (H₂0), various admixtures (Adm. #1-#3), various colors (1-4), under the control of controller 314. This ability to add material or components at the muzzle dynamically is what leads to the dynamic 3D cement printing and greater control and precision of the end product as described herein. As explained below, the key to the dynamic printing is to understand that whatever is coming out of nozzle 308 represents 100% of the volume that can be output by the nozzle 308. The may seem obvious, but this realization allows controller 314 to then dynamically control how much of the various component materials are provided, either to mixer 304, or at the nozzle 308. In other words, if more water needs to be provided at the nozzle, then the amount of some other component or components must be reduced. If color is starting to be added at the nozzle, then again, some other component or components must be reduced, because obviously 100% volume cannot be exceeded.

The main parameters that controller 314 uses to dynamically control the supply of material and the output from nozzle 308 are temperature at the nozzle, pressure at the nozzle, velocity of material existing the nozzle, and the color output. As noted above, heat control is typically performed at the mixer 304, through chemicals or other admixtures, ice, cold or hot water, etc. But as noted, this is type of control is extremely macro and does not allow for the micro control provided by the dynamic control processes described herein that are needed to achieve the precision processes required by the industry.

In order to control the heat at the nozzle, some form of heating mechanism 312 is required at the nozzle, as well as a temperature sensor to feedback the temperature to controller 314. Section 1.4 describes various nozzle 308 designs that include the appropriate heating mechanism 312 and feedback to controller 314. Section 2.1 describes a process for heat control using, e.g., the nozzle designs of Section 1.4.

### Nozzle Designs

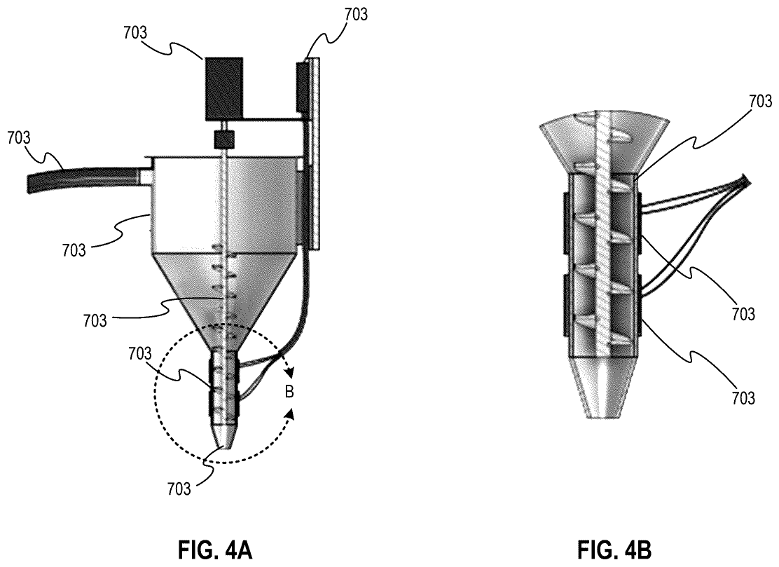

FIGS. 4-6 illustrate example designs for nozzle 308 in accordance with several example embodiments. First, in FIG. 4A, it can be seen that nozzle 308 can comprise a material hopper 402 and an auger 404 that pushes the material through the nozzle 308. Thus, if as illustrated in FIG. 3, material is being added at nozzle 308, it can be held in hopper 402, and mixed to some degree by auger 404 as the mix is being pushed out of nozzle 308. It can be further seen that the nozzle design of FIG. 4, includes an input 406 that is coupled to pump 310, as well as a motor 408 to drive auger 404.

As can also be seen, the nozzle 308 of FIG. 4A can also include a tube portion 410 below hopper 402 on which heating mechanisms 312 can be coupled. In this example, the heating mechanisms 312 can be heating bands that are interfaced with a heating controller 412 that can be interfaced with controller 314 and configured to control heat applied to tube portion 410 via heating elements bands 312. As noted above, nozzle 308 can include sensors (not shown) that feedback temperature information to heating controller 412 and/or controller 314 such that the heat of tube portion 410 can be properly controlled in order to produce the desired mix at print nozzle portion 314. Print nozzle portion 414 is where the material is extruded.

FIG. 4B is a blown up view of tube portion 410 illustrating the auger 404 in more detail and with heating bands 308. It should be noted that auger 404 can include through holes 114 as illustrated in FIGS. 3A-C in U.S. patent application Ser. No. 18/640,894 (the '894 Application), which is incorporated herein by reference in its entirety as if set forth in full. This can be especially beneficial if other material, such as plastic is being mixed and extruded through nozzle 308.

As noted in the '894 Application with reference to FIGS. 3A-C therein: “the auger 103 can include a flight 104 and a through hole 134 for connecting the auger 103. The flight 104 can also include a perforation 114. The auger 103 can be disposed within the mixing tube 105. The auger 103 can be configured to promote mixing and pumping of the cementitious material through the mixing tube 105 in order to provide a homogeneous distribution of heat throughout the cementitious material when the heating element 107 transfers heat to an interior portion 115 of the mixing tube 105. In particular, the perforations 114 running through the flights 104 can promote a mixing of heated cementitious material from the chamber walls into the body of the mix while pumping, affecting a homogeneous distribution of heat throughout the cementitious material extrusion. In certain embodiments, as described above, a motor 124 can be configured to drive the auger 103.”

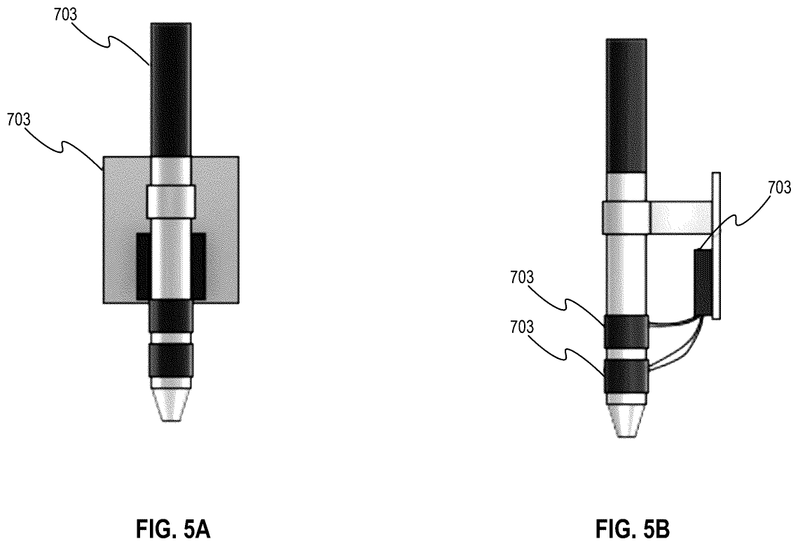

FIG. 5A and B illustrate another example embodiment of nozzle 308. Here, the nozzle 308 clearly does not include hopper 402 or auger 404. Rather, nozzle 308 of FIG. 5A and B includes an input 506 that is coupled to pump 310 on one side and to a tube portion 510 of nozzle 308 on the other, which can in turn be couple to a print nozzle 514. Tube portion 510 can then be coupled with a mounting plate 516 that mounts nozzle 308 to the robot.

As illustrated in FIG. 5A a heating controller 512 can be included, and can be mounted on mounting plate 516 in order to control heating mechanisms, in this case again bands 312, e.g., in conjunction with controller 314 and possibly based on feedback from temperature sensors (not shown) included in the nozzle design of FIG. 5A and B.

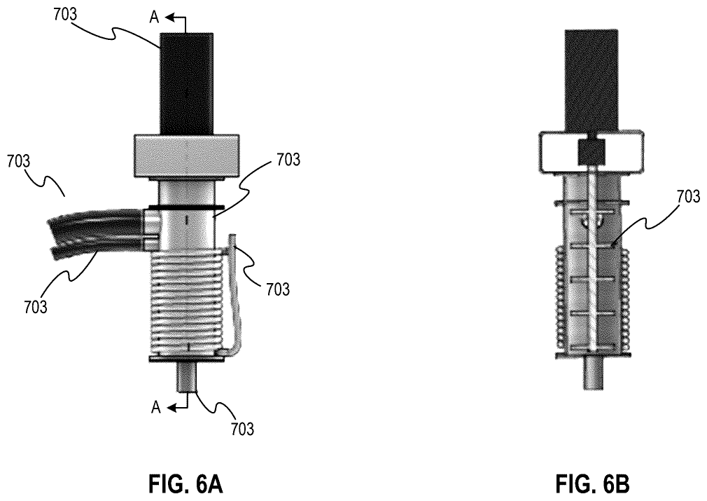

FIG. 6A and B illustrates yet another example embodiment of nozzle 308. In this example, it can be seen that input 606 from the pump 310 can be accompanied by input(s) 618 that can be used to provide water, admixtures #1-#3, and/or colors 1-4, to nozzle 308. It should be noted that such an input(s) 618 can be included in the designs of FIGS. 4 and 5, as well as the designs of the '894 Application.

In the example of FIG. 6A and B, a mixing cell 620 can be included with an auger or mixer 604 and a motor 608 to drive mixer 604.

Also, in this example, liquid heating can be included where tubing 620 brings temperature controlled liquid to the mixing cell 620, e.g., under the control of a pump (not shown) and, e.g., controller 314. Again, a temperature sensor can be included to provide temperature feedback to, e.g., controller 310. It should also be noted that heating bands, as described with respect to FIGS. 4 and 5 can also be included with the design of FIG. 6, as can the liquid temperature control of FIG. 6 be included in the designs of FIGS. 4 and 5.

Mixer 604 pushes the mix out of printing nozzle 614.

### Process Overview

Embodiments of processes for dynamic 3-Deminsional (3D) concrete printing will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### Dynamic Heat Control

Temperature control using liquid, electronics, or air for cooling and/or heating.

At the cement mixer is a common place to heat or cool concrete traditionally with ice or hot water. Heating of the aggregate bins is commonplace for cold weather concreting. While the practice of temperature control in the mixer is helpful for 3D concrete printing it does not have the finite control and immediate change in fresh state properties that are needed for affecting printability of the cement-based mortar.

The systems and methods described herein allow for heating and cooling after the mixer, namely at the nozzle 308. Importantly, as will be described in more detail below, several aspects can be controlled at the nozzle 308, but temperature control, which as described in an important component to getting the type of precision and quality that is heretofore escaped the industry.

The temperature control can be accomplished via a pump hose, or as an attachment, as described above, after the pump hose leading into the extrusion nozzle 308, and/or in/on the extrusion nozzle 308, and/or in/on the hopper or day tank 106, and/or in/on the mixer 304, and/or any combination of the above.

In systems using a pump 310 to pump the mix directly to the extrusion nozzle 308, the temperature control can be controlled in/on the extrusion nozzle under control of controller 314. In order to do this some type of temperature sensor, i.e., a thermocouple (not shown) can be included in order feedback temperature information to the controller 314, such that algorithms running on the controller can determine whether to increase or decrease the temperature of the mix at the nozzle. The same sensor loop can be used if the temperature is being controlled at the mixer 304, or hopper 306, but the variables change the further away from nozzle 308 the temperature control resides. Note regardless of where the temperature control mechanism resides, the sensor, i.e., thermocouple can still reside at the nozzle 308, as the temperature at the actual nozzle 308 is what is important. Conventional systems base temperature control, based on laboratory conditions as described above. But 3D cement printing does not occur in a lab. Thus, what the actual temperature is at the nozzle will not normally be what is expected via conventional temperature control processes based on lab conditions. And the temperature at the nozzle during actual printing is what is important. Thus, having temperature sensing at nozzle 108 allows more precise control regardless of where the temperature control resides.

The following illustrate how heat control can be accomplished at the various points in the chain illustrated in FIG. 3. These examples begin with a mix that has the desired properties of setting time and workability for pumpability and printability considering modified temperature control. Heat, cold, or chemicals can be used to modify the temperature.

Heated at nozzle example: When advantageous to reduce rate of temperature rise, pre-heat pump hose or preheat section before extrusion nozzle 108 to gradually increase cement-based printing material temperature. This gradual increase in temperature will increase the reaction of the cement and bring it closer to its ideal intermediate state of rheology and initial set for 3D concrete printing. Heat can then be applied in/on the extrusion nozzle 108 to bring the cement-based printing material to temperature where ideal fresh state properties, intermediate state properties, and hardened state properties will be achieved.

Hopper to nozzle technology example: In the first example start with a cement-based binder that is highly reactive, and therefore more readily influenced by temperature. The cement-based printing material starts at, e.g., 65 degrees F. in the hopper 306 prior to the extrusion nozzle 108, which would allow the material an hour to enter final set, and has proper rheology for the hopper 106, but not for printing. If printed at this temperature the part would fall under its own weight as the layers build up. Temperature is applied by multiple temperature-controlled heating bands (see example above) on the outside of the extrusion nozzle 308. This brings the temperature of the extrusion nozzle 308 up and increases the temperature of the cement-based printing material from, e.g., 65 degrees to, e.g., 95 degrees. At, e.g., 95 degrees the mortar is at the ideal temperature for this print for proper printing properties. The rheology is such that the material is thickened to stand layer over layer. The initial set time is increased so the layer is forced into initial set for desired buildability. The initial set time is not too much that the next layer or inter layer deposition will be too long that the layers will not bond. The final set is accelerated so that the building of additional layers will not cause the print to fail due to the weight of the layers above.

Cooled at mix cell heated at nozzle example: In this example a pump 310 is used to mix cell to nozzle technology and using chemicals added at the mixer 304 to activate the mortar and cause its modified rheology and set time. In this example the cement-based printing material is highly reactive, and a polymer with a lower glass transition temperature is used. In this application when an accelerator is applied in the mixer 304 the accelerator creates an immediate reaction and therefore causes a gradual increase in the mixer 304 temperature that is not desirable for the polymer admixture whose glass transition temperature is lower than the chamber temperature. This if not controlled causes the polymer to begin to solidify in the mixer 304 rather than after the cement-based printing material has been extruded from the extrusion nozzle 308. Cooling can then be applied to the mixer 304 to delay the reaction of the accelerator and thereby delay the solidification of the polymer by not reaching its glass transition temperature. Optionally heat can be placed at the nozzle 304 as in the above example to bring the mortar to an optimal printing temperature.

But with volumetric control, as described in more detail below, and dynamic heating as described above, dynamic mixing of components can now occur at the nozzle 308, as illustrated in FIG. 3. In other words, component mixing at mixer 304 can be set as in conventional processing, but as the heat is measured, e.g., at nozzle 308, not only can the temperature be changed, via a heating element 312 at the nozzle, but water and various admixtures #1-#3 can be added as need to adjust the heat and other characteristics of the mix at the point of extrusion. This allows for even greater precision and quality of the characteristics of the mix at the extrusion point.

### Volumetric Control

In addition to dynamic heat control, system 300 can also be configured to provide dynamic volume control at nozzle 308 that provides even further precision and quality with respect to the end product. As noted in FIG. 3, one can start with the fact that the volume of the mix output at nozzle is 100% and then move backward to modulate what is being added, first from bins 302 a-f, but then further as components are added at nozzle 308, such as water, admixtures #1-#3 (it should be noted that more or less admixtures can be added at the nozzle 308), and colors 1-4. In other words, there is only so much volume of mix/material that can be output from nozzle 308.

Thus, if water and/or admixtures are being dynamically added as described above, then the volume would obviously go over 100% unless controller 318 reduce the amount of some of the materials 102a-f being added to mixer 304 and/or reduces the amount of mix being pumped to nozzle 108. It should also be noted that the velocity of material being pumped to nozzle 108 can also be controlled by controller 308, which obviously modulates the volume being extruded, which adds another variable into the control algorithm.

Another aspect that can be dynamically controlled is color that can be included in the mixture. In the example of FIGS. 3, 4 colors 1-4 are illustrated as being capable of being added at nozzle 308. It will be understood that it only takes a limited number of colors to be able to create all other colors. Conventionally, if an end product is to be colored, then color would be to be added at the mixer 304. Achieving the correct color is then a trial and error process of adding various colors to the mix, printing products, examining the color and then starting over, after varying the amount of various colors added, until the desired color is achieved.

But with the dynamic control, e.g., provide by controller 314, the amount of the different colors 1-4 to be added can be programmed and then varied at the nozzle 308 until the desired color is achieved. This process can be performed in a matter of minutes, whereas the conventional process of mixing, printing, changing, mixing printing again, and on and on until the desired color is achieved not only take much longer, but wastes significantly more material.

The dynamic changing of the colors can be done manually based on observation, or, e.g., computer vision can be used to ascertain whether the color is correct and then automatically change the color mix, removing the need for manual interaction. In fact, sensors (not shown) can be included to monitor/measure all, or some of the inputs to nozzle 308 and feed back information to controller 314 that can then be used to automatically drive the dynamic modulation of inputs, velocity, etc., at nozzle 308. Temperature sensing was described above, but various other sensors can be included to allow controller 314 to understand the rheology, shear, etc., of the mix being extruded such that the various component inputs can be dynamically controlled to achieve the optimum output.

In fact, the color output can be used to determine whether effective mixing is occurring at the nozzle 308. If multiple colors are being added at nozzle 308, then even if the color is not quite right yet, the mix should have a smoothly blended color, as it is being extruded. If efficient mixing is not occurring, then the color would be streaky, not consistent, etc. Thus, observation of color can provide dynamic feedback and corresponding control of mixing at nozzle 308.

Conventional concrete mixing systems use rocks and large volumes to produce the energy required to sheer the water for a homogeneous and thus proper mix. in the mixer to help get the correct mix. But that is limiting in what such a system can produce in terms of the output. The dynamic control as described above, allows for the elimination of the rocks, which allows higher intensity mixing, which allows for rapid batching and opens up more capabilities, better precision, more efficiency, etc. Stated another way, the dynamic control describes allows higher shear in the mixer(s) and better temperature control, which allows better controlled concreting.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A 3D printing system for printing of cementitious material, comprising:
a mixer configured to mix the cementitious material;
a plurality of bins configured to hold and supply material to the mixer;
a pump configured to provide the cementitious material to the deposition nozzle;
a deposition nozzle configured to extrude cementitious material;
a heating element in communication with the deposition nozzle, the heating element configured to transfer heat to the cementitious material within an interior portion of the mixing and deposition nozzle; and
at least one sensor configured to generate temperature readings for the cementitious material; and
a controller coupled with the at least one sensor, the pump and the bins, and configured to receive the temperature readings, and control the pump, the amount of material being supplied by the bins, and the heating element so as to ensure that the hardening process of the cementitious material is optimum.

2. The system of claim 1, wherein the deposition nozzle is further configured to receive materiel at the nozzle, and wherein the deposition nozzle comprises a mixing chamber and an auger for mixing at the cementitious material at the nozzle.

3. The system of claim 2, wherein the controller is further configured to control the volume of the material received at the nozzle, as well as the volume of material provided by the pump so as to ensure that the hardening process of the cementitious material is optimum.

4. The system of claim 1, wherein the material held by the binds include at least some of fiber, sand, cement binders, ice, water, and various admixtures.

5. The system of claim 3, wherein the material received at the nozzle comprises at least some of water, various admixtures, and color.

6. The system of claim 1, wherein the controller is configured to receive information concerning temperature at the deposition nozzle, pressure at the deposition nozzle, velocity of material existing the deposition nozzle, and a color output and to control the amount of material being supplied by the bins, and the heating element so as to ensure that the hardening process of the cementitious material is optimum.

7. The system of claim 3, wherein the controller is configured to receive information concerning temperature at the deposition nozzle, pressure at the deposition nozzle, velocity of material existing the deposition nozzle, and a color output and to control the amount of material being supplied by the bins, the volume of the material received at the nozzle, and the heating element so as to ensure that the hardening process of the cementitious material is optimum.

8. The system of claim 1, wherein the controller is configured to implement volumetric control to control the amount of material being supplied by the bins, and the heating element so as to ensure that the hardening process of the cementitious material is optimum.

9. The system of claim 3, wherein the controller is configured to implement volumetric control to control the amount of material being supplied by the bins, the volume of the material received at the nozzle, and the heating element so as to ensure that the hardening process of the cementitious material is optimum.

10. A 3D printing system for printing of cementitious material, comprising:
a mixer configured to mix the cementitious material;
a plurality of bins configured to hold and supply material to the mixer;
a pump configured to provide the cementitious material to the deposition nozzle;
a deposition nozzle configured to extrude cementitious material, receive materiel at the nozzle, and wherein the deposition nozzle comprises a mixing chamber and an auger for mixing at the cementitious material at the nozzle;
a heating element in communication with the deposition nozzle, the heating element configured to transfer heat to the cementitious material within an interior portion of the mixing and deposition nozzle; and
at least one sensor configured to generate temperature readings for the cementitious material; and
a controller coupled with the at least one sensor, the pump and the bins, and configured to receive the temperature readings, and control the pump, the amount of material being supplied by the bins, the volume of the material received at the nozzle, and the heating element so as to ensure that the hardening process of the cementitious material is optimum.

11. The system of claim 10, wherein the material held by the binds include at least some of fiber, sand, cement binders, ice, water, and various admixtures.

12. The system of claim 10, wherein the material received at the nozzle comprises at least some of water, various admixtures, and color.

13. The system of claim 10, wherein the controller is configured to receive information concerning temperature at the deposition nozzle, pressure at the deposition nozzle, velocity of material existing the deposition nozzle, and a color output and to control the amount of material being supplied by the bins, and the heating element so as to ensure that the hardening process of the cementitious material is optimum.

14. The system of claim 10, wherein the controller is configured to receive information concerning temperature at the deposition nozzle, pressure at the deposition nozzle, velocity of material existing the deposition nozzle, and a color output and to control the amount of material being supplied by the bins, the volume of the material received at the nozzle, and the heating element so as to ensure that the hardening process of the cementitious material is optimum.

15. The system of claim 10, wherein the controller is configured to implement volumetric control to control the amount of material being supplied by the bins, and the heating element so as to ensure that the hardening process of the cementitious material is optimum.

16. The system of claim 10, wherein the controller is configured to implement volumetric control to control the amount of material being supplied by the bins, the volume of the material received at the nozzle, and the heating element so as to ensure that the hardening process of the cementitious material is optimum.
